(19) United States
(12) Patent Application Publication
(10) Pub. No.: US 2012/0292488 A1
(43) Pub. Date: Nov. 22, 2012

(54) OPTICAL SHUTTER DIMMING HELMET VISOR

(76) Inventor: Hamid Saadat, Saratoga, CA (US)

(21) Appl. No.: 13/471,249

(22) Filed: May 14, 2012

Related U.S. Application Data
(60) Provisional application No. 61/487,144, filed on May 17, 2011.

(51) Int. Cl. G01J 1/44; G02F 1/01

(52) U.S. Cl. 250/214 AL; 359/238

(57) ABSTRACT

Provided is a dimming helmet visor incorporating optical shutter technology therein for instantaneous conversion from a clear state to a dark state and vice versa. These visors find utility in helmets for anyone in changing lighting conditions outdoors, especially motorcyclists. The visor's optical shutter display is connected to a photodiode and a battery with both automatic and manual adjustment functionalities. A manual on/off switch is provided for power management. The photodiode responds to light intensity above a certain threshold and switches from a clear state to dark state in a matter of milliseconds once this threshold is reached.

### CROSS-REFERENCES TO RELATED APPLICATIONS

This application claims priority from co-pending U.S. Provisional Application Ser. No. 61/487,144 filed May 17, 2011 which is herein incorporated by reference in its entirety.

### BACKGROUND

1. Field of the Invention

The present invention relates to new uses and applications for optical shutter technology. More specifically, the present invention applies optical shutter technology in a curved panel. Most specifically, the present invention is directed to use of optical shutters in curved panels as helmet visors to improve visibility by reducing glare and blinding sunlight for motorcyclists.

2. Description of the Related Art

Traditionally, to reduce the impact and brightness of sunlight motorcyclists could wear sunglasses or have tinted glass panels and visors integrated with their helmets. Disadvantages of fixed tint mediums are that they do not address a riding environment exhibiting variable and erratic fluctuations in brightness. For example, in California where there are over 1.3 million licensed motorcyclists, lighting conditions while riding can be highly variable and can change dramatically and abruptly. This is the result of light reflecting off the vast body of water in the Pacific Ocean and tortuous highway roads that wind through canyons and mountains. Sunlight reflection off of the ocean creates extremely bright blinding conditions and glare.

Further, canyons and mountains with variable topography and shadow-casting vegetation results in quickly changing levels of brightness, shading, and shadows. In such conditions fixed tint mediums for sunglasses, helmets, and visors result in imperfect visibility. The need to have shades covering the eyes to see in the brighter conditions can result in a view that is too dark for crevices and valleys. Similarly, the need to be able to see something through the shades in the darker regions frequently results in riders wearing inadequate shades for the brightest regions. Extended riding in bright conditions with inadequate shades can lead to headaches, eye strain, cataracts, and accidents.

According to the California Motorcyclist Safety Program, a governmental program of the State of California, in 2005, 411 motorcyclists were killed and an additional 9,347 were injured in traffic collisions in California. Despite the fact only 2.1% of all vehicles registered in California are motorcycles, motorcyclists account for 9.4% of all traffic fatalities statewide. Additionally, statistics on motorcyclists show a disproportionate rate of collisions compared to numbers of riders and to other traffic. National Highway Traffic Safety Administration data shows that for the same per-mile exposure, motorcyclists are roughly 28 times more likely to die than occupants of other vehicles! Of the motorcycle-involved collisions, 65% of the fatal and 56% of the injury collisions were the fault of the motorcyclist. (See California Motorcyclist Safety Program at http://www.chp.ca.gov/programs/motorcycle.html) At least some of these collisions and accidents could be reduced by light-sensitive visors that provide motorcyclists with improved visibility to avoid incidents and to make better riding decisions.

It would be desirable to provide light-sensitive visors capable of adjusting both automatically and manually. Automatic adjustment is needed when lighting conditions change so quickly that the rider doesn't have time to think about and manually implement the change. Automatic adjustment is also helpful when the rider's hands need to be on the bike for proper steering in a turn or for control and stability at high speeds. Manual adjustment is needed as a default mechanism for safety if the electronic automatic adjustment system fails and for riders to tune the brightness more precisely to individual preferences and sensitivities.

Another modern alternative to fixed tint mediums in sunglasses and visors is electronic tinting or e-tinting with dynamically changing tinting incorporated into the glass or visor materials. The technology in darkening and lightening sunglasses provides a gradual change that takes time to adjust to ambient light conditions. This gradual change and minimum conversion time is okay for many purposes and applications but presents a major problem for motorcyclists traveling at high speeds through rapidly changing ambient light conditions. Accordingly, there is a need for a visor that changes almost immediately from a clear state to a dark state. The present invention addresses this problem.

Additionally, none of the tinting or e-tinting products currently in the market can get dark enough to block enough of the strong lights like sun or hi-beam lights from an oncoming vehicle heading in the opposite direction. Temporary blindness from oncoming hi-beams of another vehicle can be a very real problem in canyons and along country roads devoid of regular street lights on a dark night when the moon is not out or when natural moonlight and starlight are blocked by fog and clouds. The optical shutter panel can act almost like a solid car visor to block incoming light almost entirely in a short time.

Current applications for optical shutter technology in windows, walls, and refrigerator doors involve photoactive materials within flat surfaces. It would be desirable to introduce optical shutter technology into flexible panels and curved surfaces to open up the possibilities for other uses of the technology to solve more problems. The present invention addresses this issue and solves these and other needs.

### SUMMARY OF THE INVENTION

Optical shutter technology provides several advantages. Among these are near instantaneous or immediate switching from a clear state to a dark state. Optical shutters can be incorporated into curved panels and flexible panels for a vast array of applications including helmets, visors, cockpit windows, car windows, boat windshields, food storage containers, shower walls, and the like. Photodiode controlled optical shutters read the intensity of sunlight and command the battery to apply a voltage which causes liquid crystals to adjust transmission accordingly. In addition to automatic adjustment manual adjustment is provided for safety and fine tuning to better satisfy user preferences. Advantageously, optical shutters are thin, lightweight, and use little power so they can be easily transported and do not prohibitively influence manufacturing and shipping costs.

While optical shutter technology has been proven to work for flat surfaces (e.g. arc welding helmet shields), it is very challenging to make it work on a curved, plastic material as the two plastic substrates that must be brought together (through fastening, glue, other adhesives, etc.) will be stretched a bit differently when curved. When curved the outer plastic substrate making a wider turn will be stretched longer than the inner plastic substrate. Making a twisted nematic (TN) liquid crystal (LC) shutter on a curved plastic operable presents a previously unaddressed challenge.

Part of this challenge is that the distance between the two glass or plastic substrates of the shutter (see FIG. 2 herein) must be kept constant and when something flexible is bent it is difficult to ensure this distance is kept constant. To assist with keeping the distance between substrates constant while the substrates are bent there are spacer beads in a middle layer of the shutter sandwiched between the two substrates. These spacer beads help to keep the space between the substrates constant.

The other technical difficulty is in the manufacture. There are no high volume manufacturing lines making plastic LC shutters or displays, and this creates challenges in terms of equipment, raw materials sourcing, and lowering the cost of the process.

Battery size may also present a challenge for use of the curved optical shutter in a helmet and for other portable applications where a lightweight, small battery is required yet adequate long-lasting battery power is desired to produce the threshold voltage that causes the optical shutter to perform.

According to one of several aspects the present invention provides a curved panel having an optical shutter, wherein the curved panel changes from a clear state to a dark state in less than one second. The radius of curvature of the curved panel may be between 100 and 140 millimeters (mm). The optical shutter may have a contrast ratio of 100:1. The clear state may be defined by 20-50% transmission, preferably 30-40% transmission. The dark state may be defined by less than 10% transmission, less than 5% transmission, or less than 1% transmission. The curved panel may change from a clear state to a dark state in less than 100 milliseconds, or 40-60 milliseconds. Switching of the optical shutter is photodiode controlled. The optical shutter may consist of a single pixel or may have a segmented, or pixilated design whereby a specific region of the panel is switched individually. The curved panel having the optical shutter may be incorporated as a visor within a helmet.

According to another aspect the present invention provides a flexible panel having an optical shutter, wherein the flexible panel changes from a clear state to a dark state in less than one second. The flexible panel having the optical shutter may be incorporated as a visor within a helmet. Or, a visor with or without an accompanying helmet may include the flexible panel with optical shutter. Or, a pair of goggles may include the flexible panel with optical shutter.

### BRIEF DESCRIPTION OF THE DRAWINGS

FIG. 1 is a schematic diagram of a curved panel optical shutter connected to a photodiode and a battery.

FIG. 2 is a schematic diagram of a side view of a liquid crystal display for an optical shutter showing an exemplary arrangement of layers.

FIG. 3 is a graph of an electro-distortional curve for a typical twisted nematic cell illustrating an exemplary responsiveness of the tilt angle of molecules that make up the liquid crystal as a function of the applied voltage.

FIG. 4 is a graph illustrating the percent transmission of light through a typical twisted nematic cell as a function of voltage.

FIG. 5 is a perspective view of a helmet including an optical shutter dimming visor.

FIG. 6 is a perspective view of a pair of dimming goggles including optical shutter lenses.

### DETAILED DESCRIPTION OF THE PREFERRED EMBODIMENTS

Briefly and in general terms, the several embodiments of the present invention integrate optical shutter technology in a curved or flexible surface or panel. One preferred application for such technology is use as a visor in a helmet for motorcyclists.

The optical shutter may consist of only a single pixel or may include multiple pixels. In one embodiment, the physical dimensions of the optical shutter are 177.8 mm (length)×25.4 mm (width)×0.25 mm (thickness) or 7 inches (length)×1 inch (width)×0.0984 inches (thickness). The radius of curvature of the optical shutter may be between 80-160 mm, 90-150 mm, 100-140 mm, 110-130 mm, or 115-125 mm. In one embodiment, the radius of curvature is 121 mm. A suitable radius of curvature for the optical shutter depends on the bend radius of the helmet shield with which it will be used.

The optical shutter panel may initially be flat yet formed within a flexible material that permits it to be curved for affixing to a final object (e.g. helmet shield or visor) with a curvature that conforms to the geometry of the object. If the optical shutter panel is initially flat it must be able to hold its characteristics when bent and affixed to a curved object. In this manner, the optical shutter may be retrofit into existing helmet shields.

Alternatively, for use in new helmet shields the optical shutter panel may be manufactured with a curved shape compatible with the curvature in existing motorcycle shields. The active material in the optical shutter is liquid crystal. This may include Twisted Nematic (TN) Liquid Crystal, Ferro-electric Liquid Crystal, pi-cell technology, or other similar shuttering technologies. Additionally, polarizers may be incorporated in the liquid crystal to achieve a desired performance while keeping the cost low. Curved optical shutters, for use as helmet visors and in other applications, may be made in accordance with the present invention without polarizers but the performance and costs would be different. For example, a special plastic substrate would be required in the absence of polarizers and possibly a different kind of liquid crystal would be used. Various characteristics of the optical shutter may vary. For example, the coating formulation, photoactive materials, color, size, and the like.

The contrast ratio of the optical shutter between light and dark states may be 1000:1, 100:1, between 1000:1 and 100:1, or 100:5, 100:10, 100:15, 100:20, 100:30, 100:40, 90:1, 90:5, 90:10, 90:15, 90:20, 90:30, 90:40, 80:1, 80:5, 80:10, 80:15, 80:20, 80:30, 80:40, or between any two of the aforementioned ratios.

Upon lighting changes or manual activation the optical shutter changes between a clear state and a dark state. The manual on/off switch assists with power management and conservation so the system can be turned off completely when not needed, e.g. in moderate conditions. The change from clear to dark and vice versa is nearly instantaneous taking less than 1 second. The transition time from clear state to dark state may take less than 100 milliseconds. More preferably, the transition time is 40-60 milliseconds or around 50 milliseconds.

In the clear state the optical shutter exhibits over 20% transmission. More specifically, in the clear state the optical shutter exhibits 20-50%, or 30-40% transmission. In the dark state the optical shutter exhibits less than 20% transmission. More specifically, in the dark state the optical shutter exhibits less than 15%, less than 10%, less than 5%, and even less than 1% transmission.

The degree of transparency or light transmission through the optical shutter may be user-activated or automatically dimming based on ambient light, for example the brightness of sunlight. The design of the shutter can take into consideration the degree of brightness or light intensity that triggers the shutter to dim, darken, or lighten. The shutter switches from the dark state to the clear state and vice versa based on light sensed by the photodiode sensor. The sensitivity of the photodiode sensor may be adjusted to set the threshold for darkening (or clearing/lightening) and to set the extent of darkening (or clearing/lightening). Specific design considerations can be fashioned based on the application. For example, the light threshold at which the shutter display switches from a more transparent state to a darker state, the darkness threshold at which the shutter display switches from a darker state to a more transparent state, how light the light states are, and how dark the dark states are.

The degree of transparency of the dark and clear states are controlled by the voltage applied to the liquid crystal shutter. Active materials in the liquid crystal respond to applied voltage to dim or clear the shutter. More specifically, when a voltage is applied to the shutter the liquid crystals (LC) therein twist or untwist. When they untwist, light enters the cell through one polarizer but cannot exit the cell due to the different orientation of the second polarizer relative to the first polarizer. The inability of light to exit the cell makes the display or shutter appear dark. The shutter can appear as dark as a solid opaque material or traditional visor that does not provide any light transmission. Conversely, when the liquid crystals of the shutter are twisted, some or all light can pass through and the display or shutter appears partially or fully transparent. The level of transparency in the clear state may be limited by the polarizers to about 30-50% transparent. In most applications this is acceptable because if 100% transparency was desired the shutter could simply be turned off manually.

In one embodiment, the shutter provides a prompt switch from clear to dark with only two states triggered by a specified threshold of light sensed by the photodiode which commands the battery to produce a voltage that triggers liquid crystals in the shutter to untwist, thereby darkening the shutter. In this manner a fixed applied voltage results in a fixed level of transparency. In another embodiment, in-between states of varying transparency between a clear state and a dark state may be provided, for example by applying an in-between voltage that is less than the voltage required to completely untwist the liquid crystals but high enough to disrupt them from their twisted configuration. In this manner, a variable voltage source provides variable voltage resulting in an adjustable transparency level.

The liquid crystal (LC) mode of the optical shutter is preferably twisted nematic (TN). The optical shutter is connected to a battery through a connector. A photodiode is in communication with the optical shutter, for example, by mounting the photodiode on the optical shutter or through a connector which may be the same connector used for the battery or another different connector. In other embodiments, the battery may wirelessly communicate with the shutter or the photodiode. For the helmet application the battery may be approximately 3 inches by 3 inches but smaller is preferable if it can be accomplished without significantly sacrificing power and life. The distance from the battery to the shutter is approximately 3 to 7 inches. The connector spans this distance and needs to be flexible to a radius of curvature between 100-140 millimeters.

The device must have an on/off switch to conserve battery power when not in use (e.g. when ambient light conditions do not require shades). The power source for the curved optical shutter may be a conventional battery, solar power through small solar cells or panels, or a rechargeable battery. Solar cells or panels may be on the outer surfaces of the helmet or elsewhere in an area on the bike that is exposed to the sun's rays. Rechargeable batteries may be recharged by one or more of solar cells or panels, electrical current (e.g. AC), a Universal Serial Bus (USB) port, and the like. The optical shutter unit is in the “ON” state while the helmet is in use.

The dimming helmet visors according to various embodiments of the present invention may be built directly into or integrated within the body of a helmet or they may be provided separate for attachment or insertion within a helmet. They may be permanent or replaceable and disposable. While these dimming visors will find particular utility as visors in motorcycle helmets they are not limited to motorcycle helmets and with modifications may also be used in most all helmets, including but not limited to: bike helmets, aviation helmets, ski helmets, ATV helmets, and for a myriad of other applications. The technology can also be used for flat surfaces including transportation windshields and windows, building windows and other light facing glass and/or plastic coverings.

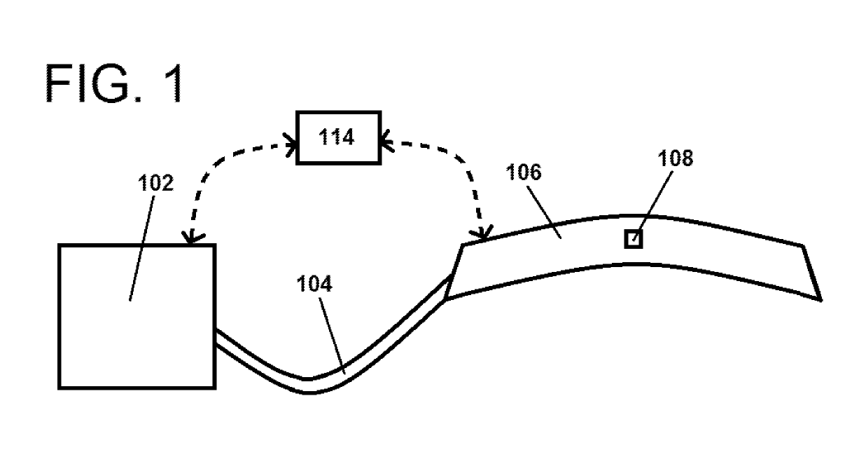

Referring to FIG. 1, a schematic diagram of an embodiment of the present invention shows the basic elements and their connections and general positions relative to each other. More specifically, a curved optical shutter 106 incorporating LC technology is powered by a battery 102. Power from the battery to the optical shutter is controlled and modulated by a photodiode 108. A flexible, resilient connector cord 104 allows the battery and photodiode to communicate with each other and the optical shutter. Alternatively, wireless technology 114 may be incorporated instead of the connector cord. While the illustrated embodiment shows a single photodiode positioned on the optical shutter, in other embodiments (not shown) a plurality of photodiodes may be provided with each of the photodiodes controlling and modulating power from the battery to the optical shutter. Additionally, in other embodiments one or more photodiodes may be positioned in other locations than on the optical shutter, instead of or in addition to a photodiode on the optical shutter, for example a photodiode on the connector cord, on the battery, on the helmet, or on a solar cell or panel.

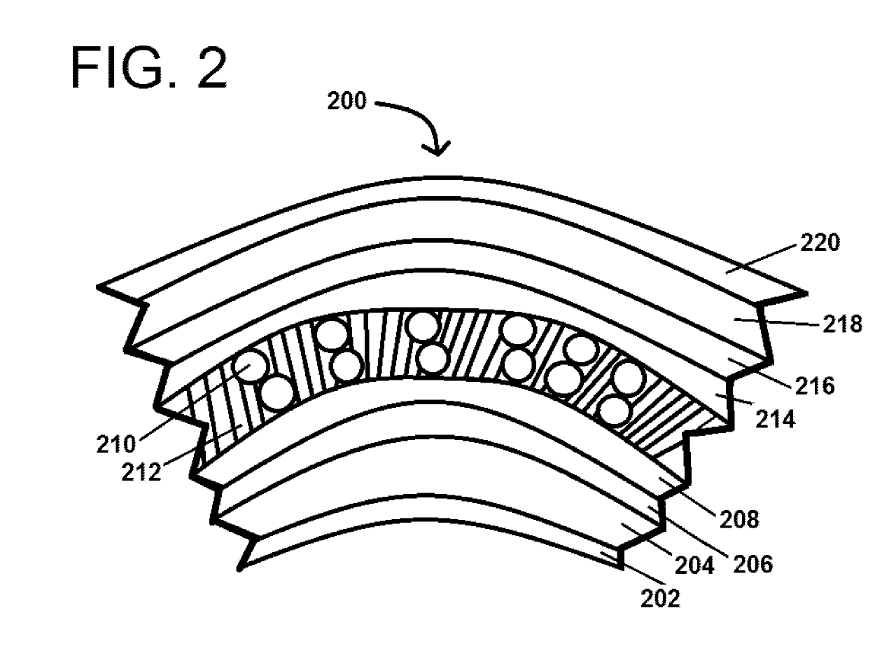

Referring to FIG. 2, the basic construction of a curved optical shutter panel 200 is illustrated. The optical shutter panel is a sandwich including several layers as shown from bottom to top: polarizer 202, glass or plastic substrate 204, electrode 206, alignment layer 208, spacer beads 210 and active liquid crystals 212, a second alignment layer 214, a second electrode 216, a second glass or plastic substrate 218, and a second polarizer 220. Most importantly, a layer of spacer beads and liquid crystals responsive to fluctuations in voltage to adjust light transmission through the shutter is positioned between the other layers. This combined layer of spacer beads and active liquid crystals may be a middle or central layer between symmetric series of outer layers on each side. In other embodiments (not shown), the spacer beads and active liquid crystals may each be in separate layers rather than a combined layer. For example, two separate layers of spacer beads may be on either side of a sandwiched liquid crystal layer. As shown the substrate may be glass or plastic, and like materials, or a combination. For example, the substrate may be substantially plastic with a thin, curved glass along one or more faces of the plastic.

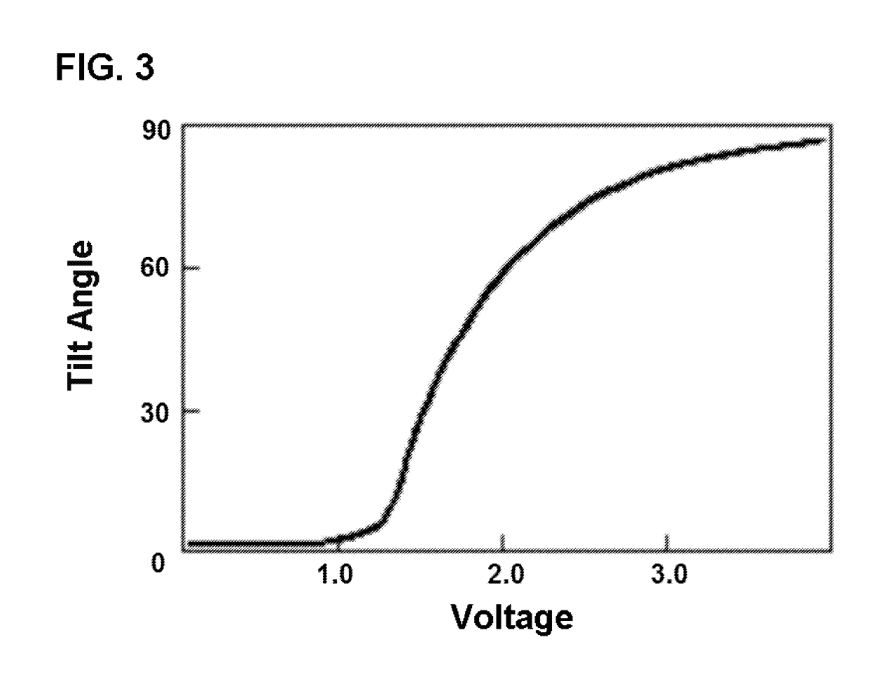

Referring to FIG. 3, a graph of the tilt angle of molecules in the liquid crystal layer is shown in response to voltage to illustrate how the shutter works. When a threshold voltage is applied the tilt angle of the molecules changes enough to cause the liquid crystals to untwist which darkens the shutter and does not permit light to exit, thereby reducing transmission.

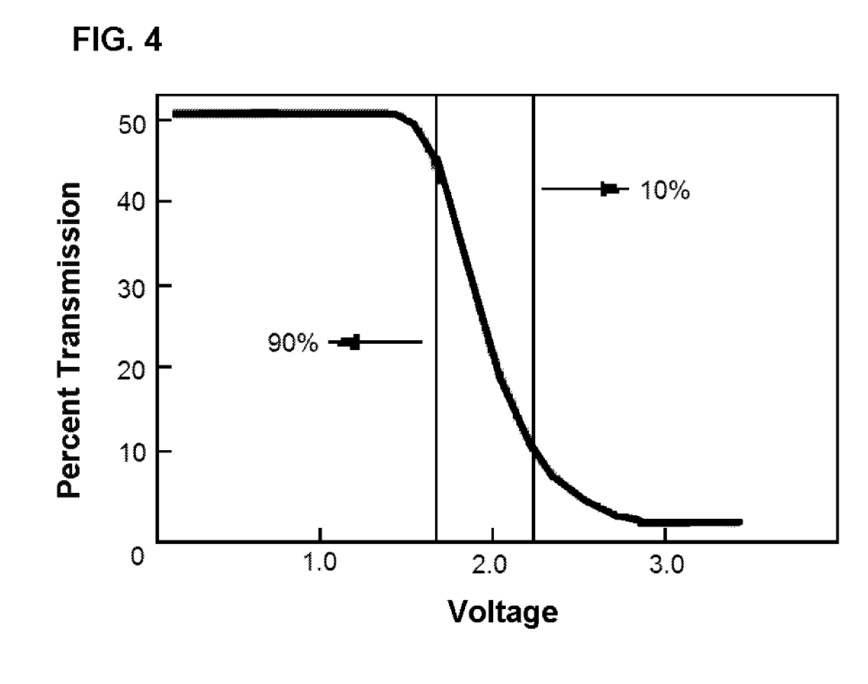

Referring to FIG. 4, in a twisted nematic (TN) type liquid crystal display for the optical shutter, the electro-distortional response as shown in FIG. 3, determines the transmission of light through the cell. A graph of the transmission of light through the cell is shown as a function of voltage.

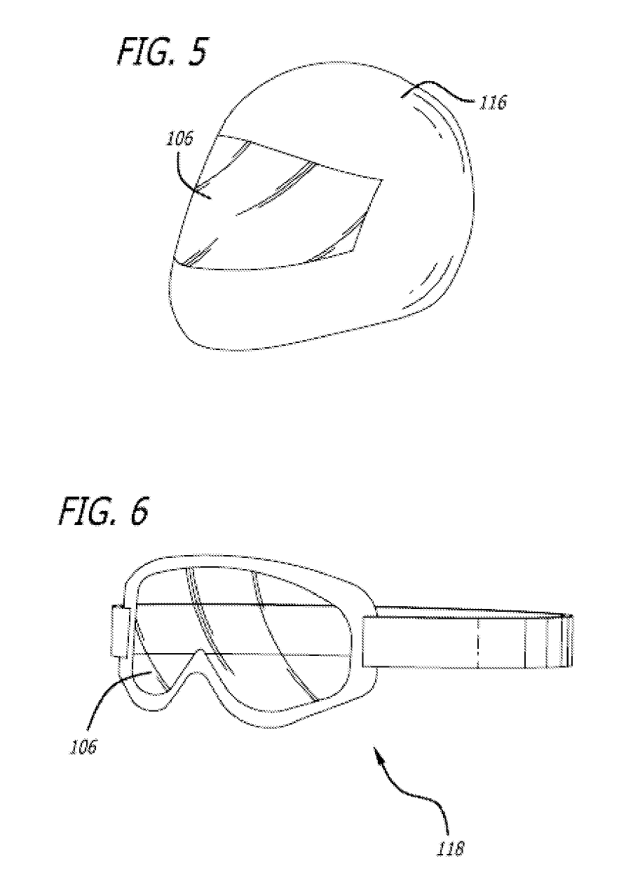

Referring to FIG. 5, one application for the curved optical shutter technology provided is as an optical shutter 106 embodied in a dimming visor for a helmet 116 to be used, for example, on motorcycles.

Referring to FIG. 6, another application for the curved optical shutter technology provided is as an optical shutter 106 embodied in a pair of dimming goggles 118 to protect the eyes to be used, for example, while performing outdoor sports including but not limited to downhill skiing, snowboarding, driving or riding snow mobiles, waterskiing, wakeboarding, jet-skiing, driving or riding wave runners, rowing or crew, sailing, power boating, and the like.

It will also be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A curved panel comprising an optical shutter, wherein the curved panel is configured to switch from a clear state to a dark state in less than one second.

2. The curved panel of claim 1, wherein a radius of curvature of the curved panel is between 100 and 140 millimeters (mm).

3. The curved panel of claim 1, wherein the optical shutter has a contrast ratio from 100:1 to 1000:1.

4. The curved panel of claim 1, wherein the clear state is defined by 20-50% transmission.

5. The curved panel of claim 1, wherein the clear state is defined by 30-40% transmission.

6. The curved panel of claim 1, wherein the dark state is defined by less than 10% transmission.

7. The curved panel of claim 1, wherein the dark state is defined by less than 5% transmission.

8. The curved panel of claim 1, wherein the dark state is defined by less than 1% transmission.

9. The curved panel of claim 1, wherein the curved panel is configured to switch from a clear state to a dark state in less than 100 milliseconds.

10. The curved panel of claim 1, wherein the curved panel is configured to switch from a clear state to a dark state in 40-60 milliseconds.

11. The curved panel of claim 1, further comprising a photodiode operably connected to the optical shutter, the photodiode configured to control switching of the optical shutter from the clear state to the dark state.

12. The curved panel of claim 1, wherein the optical shutter consists of a single pixel.

13. The curved panel of claim 1, wherein the optical shutter comprises a panel having a plurality of pixels and an individual region of the panel having at least one of the plurality of pixels is configured to switch from a clear state to a dark state independently of other regions of the panel.

14. The curved panel of claim 1, wherein the optical shutter comprises multiple pixels.

15. A helmet comprising the curved panel of claim 1 incorporated as a visor therein.

16. A flexible panel comprising an optical shutter, wherein the flexible panel is configured to switch from a clear state to a dark state in less than one second.

17. A helmet comprising the flexible panel of claim 16 incorporated as a visor therein.

18. A visor comprising the flexible panel of claim 16.

19. A pair of goggles comprising the flexible panel of claim 16.
